(19) United States
(12) Patent Application Publication
(10) Pub. No.: US 2021/0129623 A1
(43) Pub. Date: May 6, 2021

(54) AIR VENT ASSEMBLY

(71) Applicant: Volkswagen Aktiengesellschaft, Wolfsburg (DE)

(72) Inventors: Steffen ZIMMER, Braunschweig (DE); Tomasz LANGE, Isenbuettel (DE); Richard HARDERS, Wolfsburg (DE)

(73) Assignee: Volkswagen Aktiengesellschaft, Wolfsburg (DE)

(21) Appl. No.: 17/085,725

(22) Filed: Oct. 30, 2020

(30) Foreign Application Priority Data
Oct. 30, 2019 (DE) 10 2019 216 772.1

(51) Int. Cl. B60H 1/00

(52) U.S. Cl. CPC B60H 1/00692; B60H 1/00564

(57) ABSTRACT

An air vent assembly, in particular for a motor vehicle, with an air vent, which has a housing having an air duct and at least one air deflector blade assigned to the air duct with a trailing edge and a leading edge. Leading edge of the air deflector blade is mounted to be pivotable about an axis of rotation assigned to the trailing edge, and has a decorative device which has at least one fixed decorative blade with a visible edge extending in extension of the trailing edge of the air deflector blade. The air deflector blade is mounted to be pivotable about the axis of rotation by means of a pivot pin on the decorative blade. The decorative blade has a radially open bearing receptacle for the pivot pin, and the housing has a bearing projection.

This nonprovisional application claims priority under 35 U.S.C. § 119(a) to German Patent Application No. 10 2019 216 772.1, which was filed in Germany on Oct. 30, 2019, and which is herein incorporated by reference.

### BACKGROUND OF THE INVENTION

### Field of the Invention

The present invention relates to an air vent assembly, in particular for a motor vehicle, with an air vent which comprises a housing having an air duct and at least one air deflector blade assigned to the air duct with a trailing edge and a leading edge, wherein the leading edge of the air deflector blade is mounted to be pivotable about an axis of rotation assigned to the trailing edge, and comprises a decorative device which has at least one fixed decorative blade with a visible edge extending in extension of the trailing edge of the air deflector blade, wherein the air deflector blade is mounted to be pivotable about the axis of rotation by means of a pivot pin on the decorative blade.

### Description of the Background Art

Air vent assemblies are known from the prior art. For example, the patent application DE 10 2015 217 230 A1 discloses an air vent assembly of the generic type. The pivotable bearing of the air deflector blade is realized in that the latter is inserted at one end with a pivot pin into a cylindrical receptacle of the decorative blade, and at its other end is inserted radially into a latching receptacle. The radial insertion takes place in the direction of the air duct or the housing of the air vent. To assemble the air deflector blade, the one end must thus be inserted in the longitudinal extension with the one pivot pin into the axial receptacle, and inserted radially with the other end.

From the patent application DE 10 2017 203 740 A1, a further air vent assembly is known in which a pivotable air deflector blade is mounted to be pivotable on the flow-off side on a decorative blade that is fixedly arranged on the housing. The patent application EP 2 962 879 A1, which corresponds to U.S. Pat. No. 10,071,615, which is incorporated herein by reference, also discloses an air vent assembly with a pivotable air deflector blade and an adjoining fixed decorative blade.

### SUMMARY OF THE INVENTION

It is therefore an object of the present invention to provide an improved air vent assembly, by means of which on the one hand the assembly of the air vent assembly is simplified and on the other hand the robustness of the air vent assembly is further improved inexpensively.

In an exemplary embodiment, an object of the invention is achieved by an air vent assembly in that the air deflector blade can be installed without great effort, and that the air deflector blade is held captive on the housing after installation and can be easily rotated. According to the invention, this is achieved in that the decorative blade has a radially open receptacle for the pivot pin arranged on the air deflector blade, and in that the housing has a bearing projection which, when the decorative blade is mounted on the housing, protrudes into the receptacle and together with the decorative blade forms a pivot bearing for the pivot pin. During assembly, the air deflector blade is first inserted radially into the receptacle of the decorative blade with the pivot pin and subsequently the housing is either pushed onto the decorative blade from the rear side, or the decorative blade together with the pivot pin is pushed onto the housing. The housing and the decorative blade are preferably designed in such a way that they can only be connected to one another such that the bearing projection protrudes into or engages radially in the receptacle. For this purpose, the decorative blade and/or the housing preferably has a guide which ensure that the individual parts are brought together correctly, in particular that the bearing projection is properly fed into the bearing receptacle when the decorative blade and housing are assembled.

The bearing projection is designed in such a way that the pivot pin is held in the receptacle free of radial play or at least substantially free of radial play. The radial play-free or almost play-free bearing ensures that rattling noises are avoided when the air deflector blade is pivoted and that the mechanics have a good look and feel. The bearing is preferably designed in such a way that the pivot pin can be rotated with little friction in the bearing formed by the bearing projection and the bearing receptacle, in order to allow for the air deflector blade to pivot easily.

The pivot pin can be fixedly arranged on the air deflector blade, so that the pivot pin moves with the air deflector blade. As a result, a relative movement between the pivot pin and the bearing projection as well as the bearing receptacle must be enabled in the bearing in order to ensure the rotary movement or the pivoting of the air deflector blade. According to an alternative embodiment, it is provided that the pivot pin is held firmly between the bearing projection and the bearing receptacle and is mounted to be pivotable in the air deflector blade. In this case, the relative movement is situated between the air deflector blade and the pivot pin when the air deflector blade is pivoted. This simplifies construction of the bearing, because manufacturing and assembly tolerances can be greater if the pivot pin in the bearing can be braced against the bearing receptacle by the bearing projection.

The pivot pin can be formed in one piece with the air deflector blade. This results in a cost-effective production of the air deflector blade and the air vent assembly as a whole. In addition, assembly is simplified. In this case, of course, the relative movement is situated in the radial bearing when the air deflector blade is pivoted, so that an at least substantially play-free bearing of the pivot pin in the bearing is preferred.

Furthermore, it is preferably provided that the bearing projection has a curved contact surface for pivotably bearing the pivot pin. For this purpose, the bearing projection has, at its free end, in particular a concave depression which serves to receive the pivot pin in the bearing receptacle in certain areas.

The pivot pin can be mounted in or on the air deflector blade, so that a pivotable bearing in the bearing receptacle can be dispensed with.

In an example, on an end of the air deflector blade facing away from the decorative blade, a further decorative blade is arranged on the housing in the longitudinal extension of the air deflector blade. The air deflector blade is thus arranged between two decorative blades, which in particular gives the appearance of a continuous blade formed by decorative blade, air deflector blade and further decorative blade.

At its end assigned to the further decorative blade, the air deflector blade can have a further pivot pin, which is designed and mounted in particular like the pivot pin described above. This also ensures simple pivotable bearing of the air deflector blade on the further decorative blade. The air deflector blade thus preferably has both pivot pins, which results in a simple assembly of the air deflector blade on the decorative blade.

In particular, the further decorative blade can have a further radially open radial bearing for the pivot pin, and the housing has a further bearing projection, which protrudes into the further bearing receptacle when the further decorative blade is mounted on the housing and, together with the further decorative blade, forms a radial bearing, in particular a pivot bearing for the further pivot pin. The air vent assembly is thus particularly characterized in that the air deflector blade is connected to the two decorative blades in the same way. This results in a simple assembly sequence and a secure pivotable bearing of the air deflector blade on the decorative blade. Alternatively, the housing or the further decorative blade for the further pivot pin has a cylindrical recess or recess for receiving the further pivot pin. In contrast to the previous embodiment, the ends of the air deflector blade are thus attached differently to the housing or to the respective decorative blade. This can be advantageous for reasons of cost. Depending on the design of the air vent assembly and its boundary conditions, different bearings for the air deflector blade can also have the advantage of making use of the available installation space.

The method according to an exemplary embodiment of the invention for producing an air vent assembly is characterized in that the air deflector blade with the pivot pin is inserted into a radially open radial bearing, and that subsequently the decorative blade and the air deflector blade are arranged on the housing in such a way that a bearing projection of the housing protrudes into the radial bearing in order to form a radial bearing, in particular a pivot bearing for the pivot pin, together with the decorative blade. This results in the advantages already mentioned.

The method according to an exemplary embodiment of the invention for producing an air vent assembly is characterized in that the air deflector blade with the pivot pin is placed on the bearing projection of the housing and the decorative blade is subsequently arranged on the housing in such a way that the bearing projection of the housing with the pivot pin is introduced in the bearing receptacle of the decorative blade and, together with the bearing receptacle, forms a radial bearing for the pivot pin. This changes the assembly sequence, but produces the same air vent assembly as a result. To facilitate the latter assembly order, the bearing projection of the housing preferably has an indentation matched to the pivot pin, in particular a curvature matched to the shape of the pivot pin, in its contact surface which aligns the pivot pin of the air deflector blade on the bearing projection and holds said pin during assembly. For this purpose, the curvature of the contact surface of the bearing projection preferably extends over at least a quarter, in particular over at least a third, of the circumference of the pivot pin.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary air vent assembly in a perspective plan view;

FIG. 2 shows the air vent assembly from FIG. 1 in a rear view; and

FIGS. 3A to 3C show an assembly process of the air vent assembly in several steps, each in a cross-sectional view.

### DETAILED DESCRIPTION

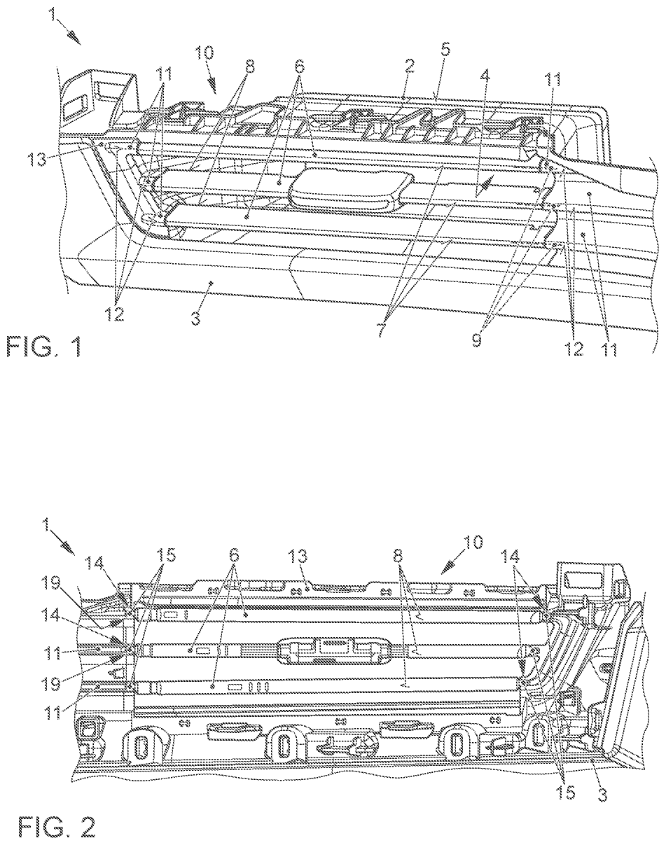

FIG. 1 shows, in a perspective plan view, an advantageous air vent assembly 1 for a motor vehicle. The air vent assembly 1 has a housing 2 which is attached, for example, to a dashboard 3 of the motor vehicle. The housing 2 forms an air duct 4 extending through the housing 2, which on a rear side 5 of the housing is or can be connected to an air conditioning and/or ventilation system of the motor vehicle, so that, in particular, conditioned fresh air can flow through the air duct 4 into the vehicle interior of the motor vehicle. In the present case, three air deflector blades 6 are also assigned to the air duct 4. The air deflector blades extend parallel to one another across the air duct 4. The air deflector blades 6 are arranged at an end of the air duct 4 facing the interior. The air deflector blades 6 each have a trailing edge 7 at their end facing the interior space and a leading edge 8 at their end facing the interior space and in particular the air duct 4. The air deflector blades 6 in particular have a wing-like cross-sectional profile and are mounted to be pivotable with their respective leading edge 8 about an axis of rotation 9 assigned to the trailing edge 7 in order to influence an air flow exiting the air duct 4. By pivoting the air deflector blades, in particular the discharge direction of the air flow can be influenced. In the present case, when mounted properly, the air deflector blades 6 are at least substantially aligned to extend horizontally, so that by a pivoting of the air deflector blades 6 about the axes of rotation 9, a discharge angle of the discharged air flow is adjustable in height in such a way that by pivoting the air deflector blades 6, the air flow, for example, can optionally be supplied to a head area or a torso area of the vehicle occupants.

Together with the air deflector blades 6, the housing 5 forms an air vent 10. In conventional air vents 10, the air deflector blades are mounted to be pivotable directly on the housing 5 and are mounted together with the housing on the dashboard 3.

According to the present exemplary embodiment, the air vent assembly 1 is supplemented by decorative blades 11. The decorative blades 11 are fixedly arranged on the housing and are therefore immobile. A visible edge 12 of the respective decorative blade 11 is formed in accordance with the discharge edge 7 of the air deflector blade 6 assigned to it and is arranged flush with it, so that optically a continuous blade of the air vent assembly results. If the air deflector blades 6 are pivoted, this is only slightly visible in the overall impression. This is in particular achieved in that the air deflector blades 6 and the decorative blades 11 on the trailing edge 7 and the visible edge 12 have the same curvature or a curvature with the same radius, viewed in cross section.

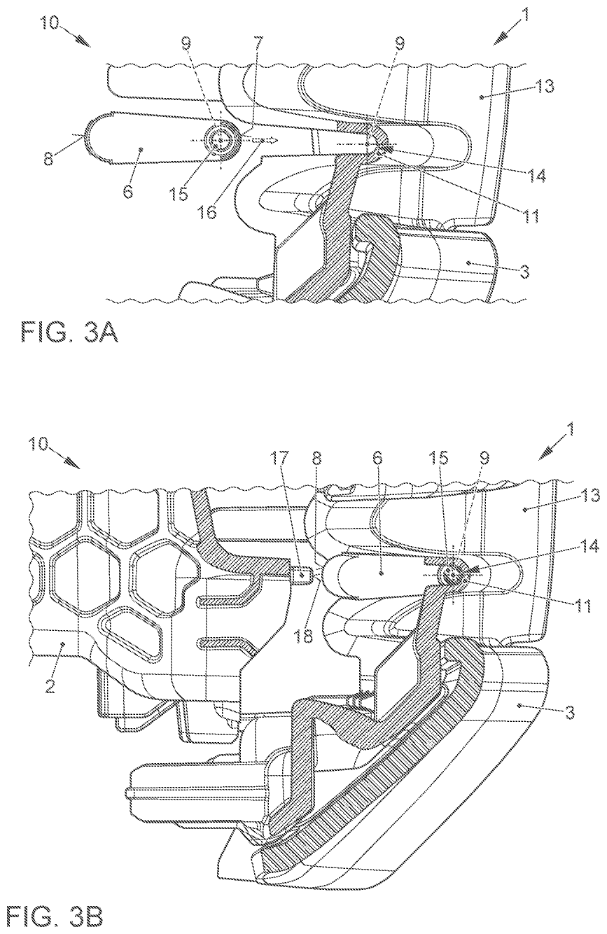

FIG. 2 shows the air vent assembly 1 in a simplified rear view in which the housing 5 has been removed. The decorative blades 11 are formed in one piece with a decorative element 13 which faces the vehicle interior and covers areas of the dashboard. The decorative blades 11 each have a radially open bearing receptacle 14 on their side facing the air duct 4 or the housing 5, which is used for the pivotable bearing of the respective decorative blade 6 assigned to it.

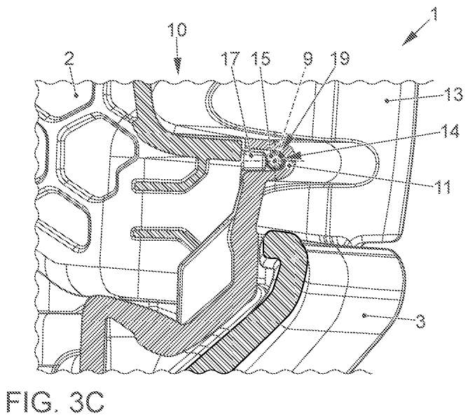

In a simplified cross-sectional view of the air vent assembly 1, FIGS. 3A, 3B and 3C each show assembly steps for manufacturing the air vent assembly 1. FIG. 3A shows a radially open bearing receptacle 14 of one of the decorative blades 11. The radially open receptacle 14 has a circular bearing contour at its bottom or base and is overall U- or V-shaped. The respective air deflector blade 6 has at its end facing the respective decorative blade 11 in each case a pivot pin 15 which is formed in one piece with the respective air deflector blade 6. The outer diameter of the pivot pin is only slightly smaller than the inner diameter of the circular base of the bearing receptacle 14 or is at most the same size.

When the air deflector blades 6 are installed, they are introduced radially with their respective pivot pins 15 into the bearing receptacles 14 of the associated decorative blades 11, as indicated in FIG. 3A by an arrow 16 and as can be seen in FIG. 2. Then, as shown in FIG. 3B, the housing 2 is supplied. Facing the decorative element 13, the housing 2 has a respective bearing projection 17 for each of the bearing receptacles 14, which is designed to be pushed into the respective bearing receptacle 14 in certain areas. For this purpose, the respective bearing projection 17, viewed in longitudinal section, is provided with a V- or U-shaped outer contour which at least essentially corresponds to the inner contour of the bearing receptacle 14. At its free end, the respective bearing projection 17 preferably has a concave contact surface 18, the radius of which at least substantially corresponds to the radius of the pivot pin 15 in the bearing receptacle 14. The respective bearing projection 17 extends far enough forward from the housing 2 that the pivot pin 15, when the housing 2 is mounted on the decorative element 13, is mounted to be pivotable due to the bearing projection 17 on the one hand and the bearing receptacle 14 or the associated decorative blade 11 on the other, with little or no radial play. The bearing projection 17, together with the bearing receptacle 14, thus forms a radial bearing 19 for the respective air deflector blade 6, as shown in FIG. 3C. By mounting the housing 2 on the decorative element 13, the pivot bearing of the air deflector blades 6 is achieved, wherein the bearing projection 17 and bearing receptacle 14 are designed in such a way that the pivot pin 15, which is formed integrally with the respective air deflector blade 6, is pivotably held about its longitudinal central axis in the respective radial bearing 19. The longitudinal central axis thus forms the above-mentioned respective rotational axis 9 for each of the air deflector blades 6, about which the air deflector blades 6 are pivoted with their respective leading edge 8.

While according to the previously explained embodiment, the respective air deflector blade 6 with the pivot pin 15 is first arranged in the bearing receptacle 14, according to a further embodiment it is provided that the respective air deflector blade 6 with the pivot pin 15 is first placed on the bearing projection 17 of the housing 2. For this purpose, the bearing projection 17 has a contact surface 18 which is adapted to or is adapted to match the circular shape of the pivot pin 15, in particular, as described above, which preferably extends over at least a quarter of the circumference of the pivot pin 15, particularly preferably over at least a third of the circumference of the pivot pin 15, so that the pivot pin 15 can be safely placed on the bearing projection 17 for pre-assembly. In this case, the decorative element 13 is only subsequently arranged on the housing 2 in such a way that the pivot pin 15 and the bearing projection 17 are inserted into the associated bearing receptacle 14 of the decorative element 13 in order to form the radial bearing 19 for the pivot pin 15 there.

According to an exemplary embodiment, the pivot pin 15 of the respective air deflector blade 6 is braced or clamped between the bearing projection 17 and the bearing receptacle or the respective decorative blade 11, and is pivotably held in or on the respective air deflector blade 6, so that the pivot movement is made possible by means of the pivot bearing of the pivot pin on the air deflector blade 6.

The embodiment shown has the advantage that on the one hand, the air vent assembly 1 can be easily mounted with few steps, and on the other, the air deflector blades 6 are captively held on the housing 2 and the decorative element 13 and can be produced and mounted with simple means.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An air vent assembly for a motor vehicle, the air vent assembly comprising:
an air vent that has a housing including an air duct and at least one air deflector blade associated with the air duct that has a trailing edge and a leading edge, the air deflector blade with its leading edge is mounted to be pivotable about an axis of rotation that is associated with the trailing edge; and
a decorative device, which has at least one fixed decorative blade with a visible edge extending as an extension of the trailing edge of the air deflector blade,
wherein the air deflector blade is mounted to be pivotable about the rotational axis on the decorative blade via a pivot pin,
wherein the decorative blade has a radially open bearing receptacle for the pivot pin, and
wherein the housing has a bearing projection which, when the decorative blade is mounted on the housing, protrudes into the bearing receptacle so as to form a radial bearing or a pivot bearing for the pivot pin together with the bearing receptacle.

2. The air vent assembly according to claim 1, wherein the bearing projection is designed such that the pivot pin is held in the radial bearing free of radial play or at least substantially free of radial play.

3. The air vent assembly according to claim 1, wherein the pivot pin is fixedly arranged on the air deflector blade.

4. The air vent assembly according to claim 1, wherein the pivot pin is formed in one piece with the air deflector blade.

5. The air vent assembly according to claim 1, wherein the pivot pin is mounted to be pivotable about the axis of rotation on the air deflector blade.

6. The air vent assembly according to claim 1, wherein the bearing projection has a curved contact surface for pivotably bearing the pivot pin.

7. The air vent assembly according to claim 1, wherein, on an end of the air deflector blade facing away from the decorative blade, a further decorative blade is arranged on the housing in a longitudinal extension of the air deflector blade.

8. The air vent assembly according to claim 1, wherein the air deflector blade has a further pivot pin at its end which is associated with the further decorative blade.

9. The air vent assembly according to claim 1, wherein the further decorative blade has a further radially open bearing receptacle for the further pivot pin, and wherein the housing has a further bearing projection, which, when the further decorative blade is mounted on the housing, protrudes into the further bearing receptacle and together with the further decorative blade, forms a further radial bearing or a pivot bearing for the further pivot pin.

10. A method for producing an air vent assembly according to claim 1, the method comprising:
introducing the air deflector blade with the pivot pin radially into the radial bearing of the decorative blade, and
arranging, subsequently, the decorative blade with the air deflector blade on the housing such that the bearing projection of the housing protrudes into the bearing receptacle of the decorative blade and, together with the bearing receptacle, forms a radial bearing for the pivot pin.

11. The method for producing an air vent assembly according to claim 1, the method comprising:
placing the air deflector blade with the pivot pin on the bearing projection of the housing; and
arranging, subsequently, the decorative blade on the housing such that the bearing projection of the housing with the pivot pin placed thereon is fed into the bearing receptacle of the decorative blade and, together with the bearing receptacle forms a radial bearing for the pivot pin there.
